(19) United States
(12) Patent Application Publication
(10) Pub. No.: US 2017/0131958 A1
(43) Pub. Date: May 11, 2017

(54) METHOD AND APPARATUS FOR CONTROLLING SMART OBJECTS WITH A COLLAGE USER INTERFACE USING NORMALIZED USER INTERFACE DESCRIPTORS

(71) Applicant: Nokia Technologies Oy, Espoo (FI)

(72) Inventors: Teemu Ilmari Savolainen, Nokia (FI); Arto Palin, Viiala (FI); Jukka Reunamaki, Tampere (FI)

(21) Appl. No.: 15/127,637

(22) PCT Filed: Mar. 21, 2014
(86) PCT No.: PCT/IB2014/060046

§ 371 Date: Sep. 20, 2016

(51) Int. Cl. G06F 3/14; G06F 3/0482

(52) U.S. Cl. CPC G06F 3/14; G06F 3/0482; G06F 2203/04803; G06F 17/2247

(57) ABSTRACT

A method, apparatus and computer program product are provided for controlling smart objects with a collage user interface using normalized user interface descriptors. A method is provided for receiving user interface description data from a plurality of utility devices. The user interface description data includes access and control data associated with the respective utility device. The method also includes generating a collaged user interface based on the user interface description data; receiving a signal associated with a first user interface description data associating the first user interface description data with a second user interface description data; and causing the collaged user interface to be displayed on a user equipment user interface.

### TECHNOLOGICAL FILED

An example embodiment of the present invention relates to control of smart objects and, more particularly, to control of smart objects with a collage user interface using normalized user interface descriptors.

### BACKGROUND

As the internet of things, for example, smart devices, increases more and new types of devices will be controllable. Some of these devices will be configured with internet connectivity and others will be smart while not connected to the internet. Users desire control for all of these devices with maximum ease and minimal trouble of delay.

Some current smart device control technology is built of verticals, with dedicated applications and/or websites for each device. This provides the user with control of the individual devices but may consume large amounts of processing power to run multiple device applications and lacks interconnectivity between devices and the user interfaces.

### BRIEF SUMMARY

A method and apparatus are provided in accordance with an example embodiment in order to control smart objects with a collage user interface using normalized user interface descriptors. In an example embodiment, a method is provided that includes receiving user interface description data from a plurality of utility devices. The user interface description data may include access and control data associated with the respective utility device. The method also includes generating a collaged user interface based on the user interface description data; receiving a signal associated with a first user interface description data associating the first user interface description data with a second user interface description data; and causing the collaged user interface to be displayed on a user equipment user interface.

In an example embodiment the method also includes receiving a control signal indication and causing the transmission of the control signal to at least one utility device of the plurality of utility devices. In an example embodiment the method the signal associating the first and second user interface description data comprises a subscribe or publish message. The method of an example embodiment also includes receiving utility device data and updating the collaged user interface based on the received utility device data. In an example embodiment the method the user interface description data further comprises resource identifiers.

In an example embodiment a method is provided including causing the transmission of a utility device user interface description data. The utility device user interface description data comprises access and control data associated with the utility device. The method also includes receiving control signals from a user device based on the user interface description data; and causing the transmission of utility device data. In an example embodiment, the method also includes executing a command based on the control signal.

In an example embodiment an apparatus is provided including at least one processor and at least one memory including computer program code with at least one memory and computer program code configured to, with the processor, cause the apparatus to at least: receive user interface description data from a plurality of utility devices. The user interface description data comprises access and control data associated with the respective utility device. The at least one memory and computer program code may also be configured to generate a collaged user interface based on the user interface description data; receiving a signal associated with a first user interface description data associating the first user interface description data with a second user interface description data; and cause the collaged user interface to be displayed on a user equipment user interface.

The at least one memory and the computer program code may be further configured to, with the processor, cause the apparatus of the example embodiment to receive a control signal indication and cause the transmission of the control signal to at least one utility device of the plurality of utility devices. In an example embodiment of the apparatus the signal associating the first and second user interface description data comprises a subscribe or publish message. The at least one memory and the computer program code may be further configured to, with the processor, cause the apparatus of the example embodiment to receive utility device data; and update the collaged user interface based on the received utility device data.

In an example embodiment an apparatus is provided including at least one processor and at least one memory including computer program code with at least one memory and computer program code configured to, with the processor, cause the apparatus to at least: cause the transmission of a utility device user interface description data. The utility device user interface description data comprises access and control data associated with the utility device. The at least one memory and the computer program code may also be configured to, with the processor, cause the apparatus to receive control signals from a user equipment based on the user interface description data and cause the transmission of utility device data.

The at least one memory and the computer program code may be further configured to, with the processor, cause the apparatus of the example embodiment to execute a command based on the control signal. In an example embodiment of the apparatus, the user interface description data further comprises support permission request data.

In an example embodiment a computer program product is provided including at least one non-transitory computer-readable storage medium having computer-executable program portions stored therein with the computer-executable program portions including program code instructions configured to receive user interface description data from a plurality of utility devices. The user interface description data comprises access and control data associated with the respective utility device. The computer-executable program code portions of an example embodiment of the computer program product may also include program code instructions configured to generate a collaged user interface based on the user interface description data; receiving a signal associated with a first user interface description data associating the first user interface description data with a second user interface description data; and cause the collaged user interface to be displayed on a user equipment user interface.

The computer-executable program code portions of an example embodiment of the computer program product may also include program code instructions configured to receive a control signal indication and cause the transmission of the control signal to at least one utility device of the plurality of utility devices. In an example embodiment of the computer program product the signal associating the first and second user interface description data includes a subscribe or publish message.

The computer-executable program code portions of an example embodiment of the computer program product may also include program code instructions configured to receive utility device data and update the collaged user interface based on the received utility device data.

In an example embodiment a computer program product is provided including at least one non-transitory computer-readable storage medium having computer-executable program portions stored therein with the computer-executable program portions including program code instructions configured to cause the transmission of a utility device user interface description data, wherein the utility device user interface description data comprises access and control data associated with the utility device; receive control signals from a user equipment based on the user interface description data; and cause the transmission of utility device data. The computer-executable program code portions of an example embodiment of the computer program product may also include program code instructions configured to execute a command based on the control signal.

In yet another example embodiment, an apparatus is provided that includes means for receiving user interface description data from a plurality of utility devices. The user interface description data comprises access and control data associated with the respective utility device. The apparatus may also include means for generating a collaged user interface; means for receiving a signal associated with a first user interface description data associating the first user interface description data with a second user interface description data; and means for causing the collaged user interface to be displayed on a user equipment user interface. In an example embodiment the apparatus also includes means for receiving a control signal indication and causing the transmission of the control signal to at least one utility device of the plurality of utility devices. The apparatus of an example embodiment also includes means for receiving utility device data and updating the collaged user interface based on the received utility device data.

In an example embodiment an apparatus is provided including means for causing the transmission of a utility device user interface description data. The utility device user interface description data comprises access and control data associated with the utility device. The apparatus also includes means for receiving control signals from a user device based on the user interface description data; and means for causing the transmission of utility device data. In an example embodiment, the apparatus also includes means for executing a command based on the control signal.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a communications diagram in accordance with an example embodiment of the present invention;

FIG. 2 is a block diagram of an apparatus that may be specifically configured for control of smart objects with a collage user interface using normalized user interface descriptors in accordance with an example embodiment of the present invention;

FIG. 3 illustrates an example simple collage user interface rendering in accordance with an embodiment of the present invention; and

FIGS. 4 and 5 are flow charts illustrating the operations performed, such as by the apparatus of FIG. 2, in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

A method, apparatus and computer program product are provided in accordance with an example embodiment for control of smart objects with a collage user interface using normalized user interface descriptors. In an example embodiment, a utility device, such as a smart device, node actuator, or the like, may be provided which provides a user equipment (UE) with a vendor independent normalized user interface description data file. The user interface description data may allow access and control of the utility device by the UE, external devices, or software modules running on the UE. The user interface description data also allows for generation and display of a control user interface in a manner in which the vendor desires. In some instances the user interface description data may allow hidden functionality, for example, without the user interface being displayed for the utility device. In example embodiments which more than one utility device user interface description data has been provided, the UE may generate and display a collage user interface including the control user interfaces for respective utility devices in a single user interface.

In an example embodiment, a UE is provided to receive user interface description data, including access and control information, from one or more utility devices which come within range of the UE. The user interface description data may allow intercommunication between the software included in the different user interface descriptions, external devices, software modules running internal to the UE using standardized application programming interfaces (APIs), such as Publish/Subscribe API (pubsub API). In an example embodiment, the user interface description data may take intercommunication permissions into account. For example, the user interface descriptor may need to request UE or user permission to communicate with restricted resources.

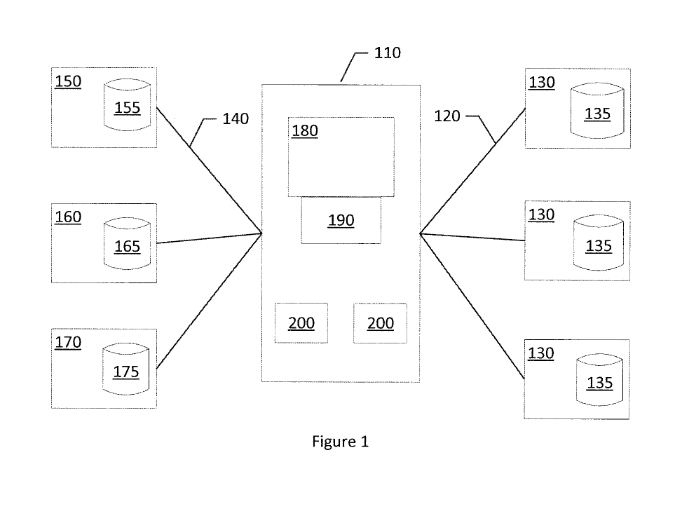

FIG. 1 illustrates a communication diagram including a UE 110, utility devices 130, and external systems 150, 160, and 170. The UE 110 may be in data communication with the utility devices 130 through a local connection 120. The UE 110 may be in data communication with the external systems such as internet servers 150, external system 160 through a local area network, and external system 170 through an internet connection 140. The utility devices may have a memory 135. The external systems 150, 160, and 170 may have associated memory or databases 155, 165, and 175 respectively. The UE 110 may have a utility device control module 180 that manages UI descriptors and that may utilize one or more application program interfaces 190, such as a Publish/Subscribe APIs to communicate and to allow communications with and between software modules 200, utility devices 130, and/or external resources 150, 160, or 170. The APIs 190 may also be used by UI description data, discussed below. A utility device may include a smart device, node, sensor, actuator, or the like. The UE 110 may be a mobile phone, tablet computer, laptop computer, personal data assistant (PDA), digital television, desktop computer, or the like.

The UE 110 may connect to one or more utility devices 130 through local connections 120. Local connections may be wireless near field communication (NFC), Bluetooth® low energy (BLE), Bluetooth®, Wi-Fi, IEEE 802.15.4, ZigBee, Z-Wave, multicast transmission, broadcast transmission, or wired connections such as IEEE 802.3, CAN bus, power-line communication (PLC) or the like. The utility devices 130 may have a user interface (UI) description data stored locally in a memory 135. The UI description data may include vendor independent and normalized control and access information for the associated utility device 130. In some example embodiments, executable code utilizing the APIs 190 may be included in the UI description data. The utility device 130 may transmit or otherwise convey the UI description data to the UE 110, as described below. After the UE 110 receives and loads the UI description data, the UE may execute the UI description data using a utility device control module 180, which may allow access to the utility device 130, render a control or collage UIs on a user interface, and execute controls contained in the UI description data. The utility device control module 180 may be associated with a single UI description data or alternatively be associated with a plurality of UI description data. During the generation of the collage UI and execution of controls the utility device control module 180 may request data from external data sources, for example, internet servers 150 which have the requested data stored in a database 155. The UE 110 may communicate with the external sources through an internet connection 140, which may be implemented as GSM, GPRS, WCDMA, CDMA, WiMAX, LTE, CDMA2000, IEEE 802.11 Wi-Fi or alike wireless radio connection, or fixed internet connection such as IEEE 802.3 Ethernet, xDSL, cable network, optical network, or alike. The utility device control module 180 and UI descriptors executed by utility device control module 180 may then use APIs 190 to communicate with each other, software modules 200 within the UE 110, external systems 160, with data sources 165 in a local area network, or with external systems 170 with data resources 175 through the internet connection 140. In some instances, the UE 110 may store UI description data in a cache memory, allowing the UE 110 to load the UI description data from the cache instead of requesting them from the utility device 130 in each use instance.

In an example embodiment, the UI description data may include HyperText Markup Language (version 5) (HTML, HTML5), which may allow rendering of the UI by most UEs. Additionally or alternatively, the UI description markup language may be HTML4, XAML, XML, QML, a mix of languages or the like. In some instances the UI description programming language may be an interpreted language, such as JavaScript® (or other forms of ECMAscript), Qt, Java, C#, C, C++, or the like. The UI description data may use a Cascade Style Sheet (CSS) or similar style sheet language for specifying the look and formatting of the user interface layout of the control or collage UI.

The UE 110 may receive the UI description data or portions of the UI description data from the utility device 130 directly or indirectly. For example the UE 110 may receive the UI description data through NFC, reading a QR code, fetching the UI as a CoAP resource from the utility device, fetching the UI description data as a HTML resource from the utility device, fetching the UI description as a BLE resource from the utility device, receiving a multicast transmission, using multicast messaging, listening to passive advertising, or the like. In an instance in which the UI description data is fetched as a CoAP or HTML resource, the resource may be HTML5 or similar markup language. In an instance in which the UI description data is received through a multicast transmission, the utility device may multicast its UI description data with utility device data for display, which may be sensor data of the utility device, such as temperature, actuator state, image data, switch position, or the like. In an instance in which, the UI description data is received using multicast messaging, the UE 110 may send a multicast CoAP request for all nodes on a link and request UI description resource data.

In an example embodiment, the UI description data may be compressed, for example, zipped, to allow transmission from the utility device 130 to the UE 110 using minimal energy and the least amount of bytes. The compression of the UI description data may be particularly important in instances in which the UI markup language is written in human understandable format, which may require significantly greater data usage. In an instance in which the UI markup language is written in a binary format the compression may be less important, due to less data being transmitted. The compression of the UI description data may be an advantage in transmission the UI description data using BLE or other low energy radios.

The UI description data may be cached in the UE 110 or provided by a proxy cache or repository node. For example, a home router may host a repository containing UI description data for respective utility devices connected to the home network. For example, UE 110 may retrieve the UI description data from the home router repository instead of receiving it from each individual utility device 130.

In an example embodiment, UI description data may be collected and shared among more than one UE 110. For example, a smart phone may send UI description data sets to a nearby smartphone automatically or upon request. In another example, a mesh network may collect UI description data for all nodes participating in the mesh network, which may result in a collective UI description data set for all current members of the mesh. For example, in an instance in which four utility devices 130 are accessible to the UE 110, the UE may receive the UI description data for all four utility devices through the mesh network or proximate UE. Additionally or alternatively the UE 110 may detect multiple utility devices 130 and receive the UI description data from each utility device detected.

UI description data may contain references to elements that may be loaded from sources other than the utility device. For example, the UI description data may contain a reference to an advertisement service; the utility device control module 180 may cause the UE 110 to dynamically load advertisements from the internet resource, while maintaining control information statically from the utility device 130.

In an example embodiment, a pubsub API, such as a JavaScript API, allows interworking with the UE 110 software modules 200 through specific platform software. The utility device control module 180 may allow UI descriptors to publish the UI description data resource identifiers and resource values using the pubsub API 190. The UI description data resource identifiers and resources values may be mapped and distributed within the UE 110. The utility device control module 180 may also allow UI descriptors to subscribe for incoming commands sending a message object command to a software module 200 to listen for new utility devices 130. In an instance in which the UE 110 has identified the appearance of a utility device 130, the software module 200 may send commands to these devices in the form of object message commands, received by the pubsub API module 190. The pubsub API 190 may then deliver the object message commands to the utility device control module 180 for handling and for delivery to UI descriptors that have subscribed to receive such commands. This allows for smooth integration and interoperation of utility devices and applications in the UE 110.

For example, in an Android® device, the pubsub API may be integrated with the Android Intent and broadcast framework. The utility device control module 180 may publish UI description data resource identifiers and resource values using the pubsub API 190. The resource identifiers and resource values may be mapped to Intents broadcast inside the UE 110. Additionally, the utility device control module 180 may subscribe for incoming commands, instantiating new BroadcastReceivers. Software running in the UE 110 may instantiate BroadcastReceivers for listening for the appearance of new utility devices, such as smart objects, nodes, or the like. Upon detection of an appearance of a utility device 130, software modules 200 may send commands to the utility devices 130 in the form of Intents, which would be received by the pubsub API's 190 BroadcastReceiver, and delivered to the utility device control module 180 for handling.

In an instance in which the access information is stored in another device, for example, internet servers 150, local external system 160, or internet accessible external system 170, the resource identifier may point to the external device. The resource identifier may be received by the pubsub API 190, which may access the external device automatically, without user interaction regarding the access process. In some example embodiments, the pubsub API 190 could implement a translator for external device communication, such as a CoAP proxy. The pubsub API 190 may translate the pubsub API actions to CoAP GET/REPLY messages for communication with nodes in a local area network or the internet.

In an example embodiment, the pubsub API may contain parameters to describe the resource identifier, resource URL, resource data, publication/subscription scope, or the like. The publication/subscription scope may restrict the UI descriptor to communication only with other UI descriptors 180, software modules 200 within the UE 110, with local area network external devices 160, internet external devices 170, or any combination thereof.

In an instance in which the UI description data causes the utility device control module 180 to access services from external devices or other modules within the UE 110, such as device location data or global position system (GPS), the UE 110 may request permission from the user. The UI description data may support permission framework, which may be mapped to various performance frameworks of the UE 110. For example, in an instance in which the UI descriptor requests access to a GPS function, the utility device control module 180 may request permission that may be mapped to the GPS function. By way of an example, in an Android platform, the utility device control module 180 permission request may be mapped to ACCESS FINE LOCATION.

In an example embodiment, the UI description data may cause the utility device control module 180 to verify the UE device 110 type and supported APIs. In an instance in which the UE 110 does not have the capability of executing all functions of the utility device UI description data, the UI descriptor or the utility device control module 180 may generate and display on the user interface instructions for installing dedicated applications for the respective utility device.

In an example embodiment, the UI description data may include device specific attributes and functional names. The device specific names may utilize addresses, such as media access control (MAC) addresses, for each device. The use of device specific names may allow the runtime integration of functions without naming conflicts. For example in an instance in which there are two utility devices from the same vendor, functions such as 02030405_setup_function( ) and 03030405_setup_function( ) may be utilized. As described above, the UE 110 may allow UI descriptors and utility device control module 180 to utilize pubsub APIs 190 automatically or upon user interaction to share information between utility devices 130. In addition to the communication association discussed above, the utility device control module 180 may associate two or more UI description data elements based on a user input, binding the elements, or automatically based on UI description data control instructions.

In an example embodiment, the UE 110 may support user initiated binding of utility devices 130. A utility device 130 binding may include selection of a utility device output data as the input data for a second utility device. The user may select UI elements using a user interface, in response the UE 110 may associate a UI description data element associated with the first utility device 130 with a UI description data element of a second UI description data, utilizing the pubsub API. For example, a user may bind two UI description data elements associated with two utility devices 130, such as a sensor and an actuator, causing the output of the sensor to be sent to the actuator as input. In this example, the UE 110 acts as the mediator for the data flow using the utility device control module or modules 180, and the sensor and actuator would not need to send data directly between each other. For example, the binding of UI elements may cause or trigger the first UI description data to cause the associated utility device control module 180 to publish the utility device output data. Additionally or alternatively, the binding of UI description data elements may cause or trigger the second UI description data to cause the associated utility device control module 180 to subscribe or listen for publications from the first utility device control module 180.

In an example embodiment, the UE 110 may associate UI description data elements based on the UI description data of at least one of the utility devices. In some example embodiments, the UI description data may include instructions to bind a first utility device description data element to a second UI description data in response to identifying a specific second utility device or utility device type. For example in an instance in which the first utility device is a home or building lighting control, the UI description data may include instructions to automatically, without user input, associate the UI description data of any newly identified lighting utility device. The UI descriptions data elements associated with the first and second utility device may be bound or associated using the pubsub API as discussed above.

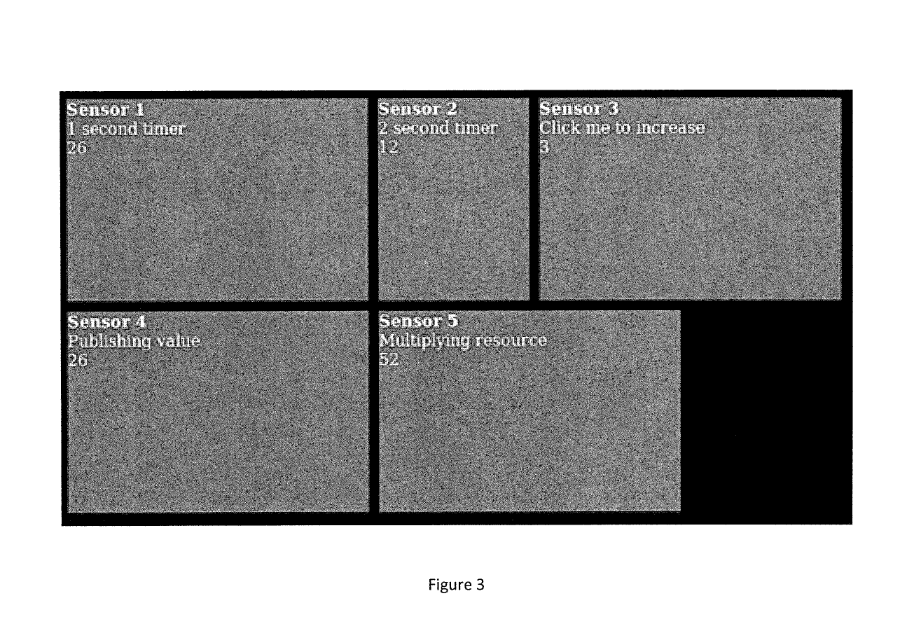

In an example embodiment, the UE 110 may generate and render a collage UI including respective UI description data to run in the same runtime environment, UI description data running in dedicated runtime, in a web browser, or on a native application. A collage UI may be an assemblage of user interface displays or controls in a single visual representation, as depicted in FIG. 3. In an instance in which the UE 110 generates and renders a collage UI in a native application, such as Windows® 8 application, the native application may use a panorama view with each utility device in a separate tile, as shown in FIG. 3.

With regard to security and privacy of the UE 110, the UE may analyze the UI description data included code to verify that the utility device control module 180 is calling and accessing only resources for which access has been allowed. In an embodiment in which multiple UI descriptors 180 are running in the same runtime environment, the code verification may be more important. Additionally or alternatively, the UE 110 may generate separate runtime environments for each UI descriptor or UI descriptor groups. As discussed above, the UI description data may utilize APIs 190 for communication between the separate runtime environment utility device control modules 180. In an embodiment in which the utility device control modules 180 are in separate runtime environments, the collage UI rendering may not appear different that a single runtime environment embodiment, thereby providing security transparent to the user.

### Example Apparatus

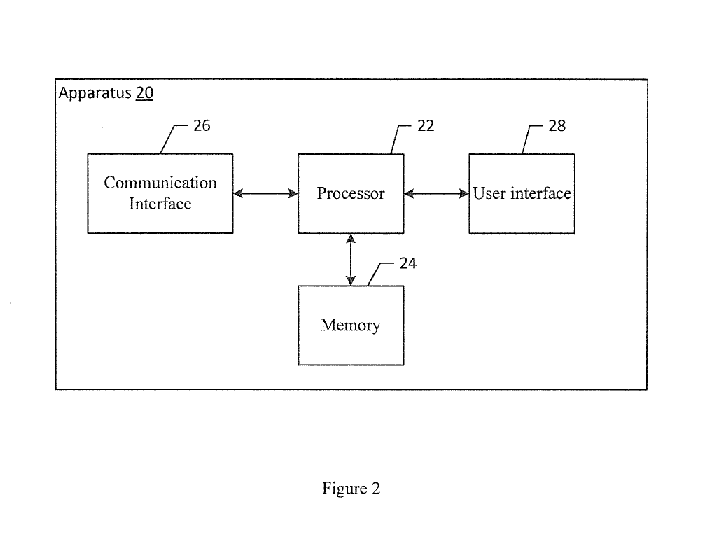

A UE 110 or utility device 130 may include or otherwise be associated with an apparatus 20 as shown in FIG. 2. The apparatus, such as that shown in FIG. 2, is specifically configured in accordance with an example embodiment of the present invention to provide for control of smart objects with a collage user interface using normalized user interface descriptors. The apparatus may include or otherwise be in communication with a processor 22, a memory device 24, a communication interface 26, and a user interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by UE 110 or utility device 130. However, in some embodiments, the apparatus may be embodied as a chip or chip set. In other words, the apparatus may comprise one or more physical packages (for example, chips) including materials, components and/or wires on a structural assembly (for example, a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include a communication interface 26 that may be any means such as a device or circuitry embodied in either hardware or a combination of hardware and software that is configured to receive and/or transmit data from/to a communications device in communication with the apparatus, such as to facilitate communications with one or more user equipment 110, utility device, or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 20 may also include a user interface 28 that may, in turn, be in communication with the processor 22 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processor may comprise user interface circuitry configured to control at least some functions of one or more user interface elements such as a display and, in some embodiments, a plurality of speakers, a ringer, one or more microphones and/or the like. The processor and/or user interface circuitry comprising the processor may be configured to control one or more functions of one or more user interface elements through computer program instructions (for example, software and/or firmware) stored on a memory accessible to the processor (for example, memory device 24, and/or the like).

### Example Collage UI Rendering

FIG. 3 illustrates an example of a simple collage UI rendering. The collage UI rendering includes five UI descriptions each including two files; a JavaScript file and a HTML file. The collage UI may be generated by a UE 110 with a HTML framework including JavaScript code. A script running on the UE 110 merges the files as follows. First the HTML header file from the framework, then JavaScript files from UI description data, then HTML file from framework to middle, then HTML files from UI description data, then the footer from the HTML framework. The framework may then call up all set up functions, which initializes and starts utility device control module 180 actions relating to each utility device 130, such as sensors 1-5. The HTML files from the UI description data defines the size, color, or the like of each tile for each respective sensor. The UE 110 then renders the collage UI as shown in FIG. 3.

Sensor 1 depicts a utility device sensor timer increasing its value each second. Sensor 2 depicts a utility device sensor increasing its value every two seconds. Sensor 3 depicts a utility device sensor which increases its value each time it is clicked or selected. Sensors 4 and 5 have been bound by the UE 110. Sensor 4 depicts a utility device sensor which increases its value every second and publishes the value for other utility devices running in the same framework to utilize. Sensor 5 receives the output value published by sensor 4 and multiplies the value by two and displays the result value.

In example embodiments, the UI descriptors associated with the tiles may utilize APIs 190 to fetch data from remote sensors, for example, such as through BLE, or push data to these utility device sensors. In further embodiments, JavaScript code of the UI description data may be used to trigger the utility device control module 180 to download advertisements or other media content.

### Example Process for Control of a Utility Device

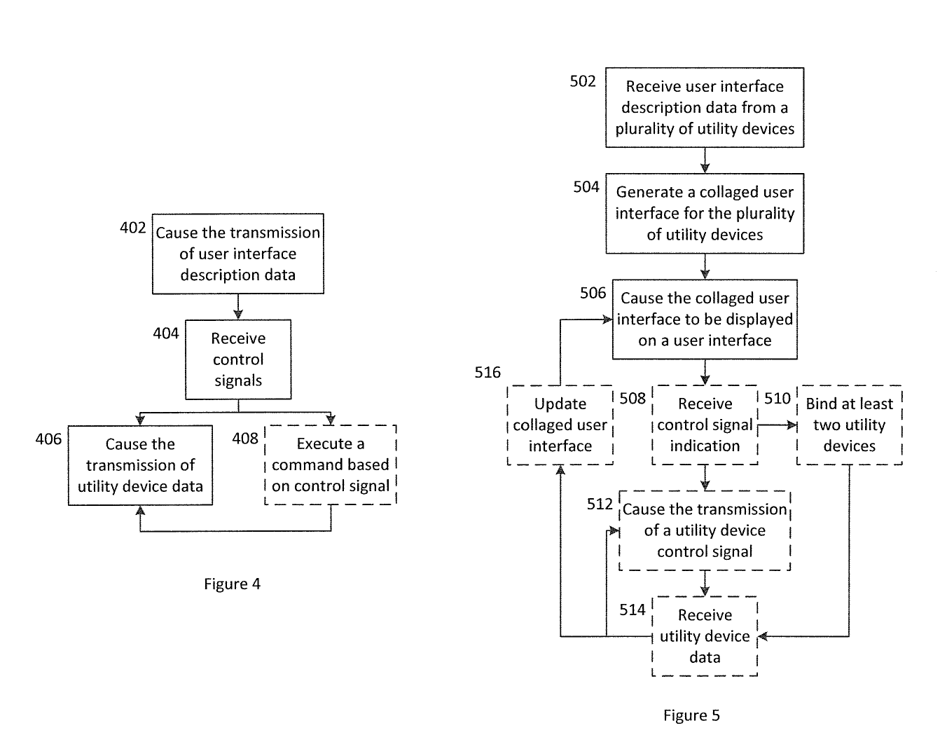

Referring now to FIG. 4, the operations performed, such as by the apparatus 20 of FIG. 2, for controlling a utility device are illustrated. As shown in block 402 of FIG. 4, the apparatus may include means, such as a processor 22, a memory 24, communications interface 26, or the like, configured to cause the transmission of UI description data. The UI description data may include vendor independent normalized control and access data associated with the respective utility device. The processor 22 may retrieve the UI description data from the memory 24. The processor 22 may cause the communications interface 26 to transmit the UI description data to a UE 110 or in some instances other devices in a network. The communications interface 26 may transmit the UI description data using NFC, BLE, multicast transmission, or the like.

In an example embodiment, the UI description data may include HyperText Markup Language (version 5) (HTML, HTML5), which may allow rendering of the UI by most UEs. Additionally or alternatively, the UI description markup language may be HTML4, XAML, XML, QML, a mix of languages or the like. In some instances the UI description programming language may be an interpreted language, such as JavaScript® (or other forms of ECMAscript), Qt, Java, C#, C, C++, or the like. The UI description data may use a Cascade Style Sheet (CSS) or similar style sheet language for specifying the look and formatting of the user interface layout of the control or collage UI.

In an example embodiment, the UI description data may be compressed, for example, zipped, to allow transmission from the utility device 130 to the UE 110 using minimal energy and the least amount of bytes. The compression of the UI description data may be particularly important in instances in which the UI markup language is written in human understandable format, which may require significantly greater data usage. In an instance in which the UI markup language is written in a binary format the compression may be less important, due to less data being transmitted. The compression of the UI description data may be an advantage in transmission the UI description data using BLE or other low energy radios.

As shown in block 404 of FIG. 4, the apparatus 20 may include means, such as a processor 22, a communications interface 26, or the like, configured to receive control signals. The communications interface may receive control signals from the UE 110 through wireless communications, such as NFC, BLE, or the like. The control signals may include a command to be executed by the apparatus. For example, the command may be open valve, adjust servo position, turn off, turn on, send data, or the like. The process may continue at 406 causing the transmission of utility device data, or 408 execute command based on the control signal.

As shown in block 406 of FIG. 4, the apparatus 20 may include means, such as a processor 22, a communications interface 26, or the like, configured to cause the transmission of utility device data. The processor 22 may cause the communications interface 26 to transmit the utility device data to a UE 110. For example, in an instance in which the utility device is a sensor, the utility device data may include temperature data, light data, motion data, position data, sound data, image data, or the like. In an example embodiment the processor may transmit utility device data at a predetermined interval or in response to stimuli, such as detection of a sound, movement, light, or the like. In another example, the processor 22 may cause the transmission of utility device data is response to a command in the control signal, as discussed in block 408.

As shown in block 408 of FIG. 4, the apparatus 20 may include means, such as a processor 22, or the like, configured to execute a command based on the control signal. For example, the processor 22 may cause the utility device to turn off or on itself or a secondary device, actuate a valve, change a servo position, or the like. In an instance in which the control signal includes a command to transmit utility device data, the process may continue at 406, as described above. The command to transmit utility device data may, in some embodiments, include transmission of an indication that the command execution status, for example, executed satisfactorily or not executed.

### Example Process for Generating a Collage UI and Utility Device Control Signals

Referring now to FIG. 5, the operations performed, such as by the apparatus 20 of FIG. 2, for generating a collage UI and Utility device control signals. As shown in block 502 of FIG. 5, the apparatus 20 may include means, such as a processor 22, a memory 24, a communications interface 26, or the like, configured to receive UI description data from a plurality of utility devices. The interface description data may include vendor independent normalized control and access information associated with the respective utility device 130. In example embodiments, the UI description data may also utilize APIs to facilitate communications within and external to the apparatus 20. The communications interface 26 may receive the UI description data directly or indirectly from the utility device 130. For example the communications interface 26 may receive the UI description data through NFC, reading a QR code, fetching the UI as a CoAP resource from the utility device, fetching the UI description data as a HTML resource from the utility device, fetching the UI description as a BLE resource from the utility device, receiving a multicast transmission, using multicast messaging, listening to passive advertising, or the like. In an instance in which the UI description data is fetched as a CoAP or HTML resource, the resource may be HTML5 or similar markup language. In an instance in which the UI description data is received through a multicast transmission, the utility device may multicast its UI description data with a value to display. In an instance in which, the UI description is received using multicast messaging, the processor 22 may cause the communications interface 26 to send a multicast CoAP request for all nodes on a link and request UI description resource data.

The UI description data may be cached in the memory 24 or provided by a proxy cache or repository node. For example, a home router may host a repository containing UI description data for respective utility devices connected to the home network. The processor 22 may cause the communications interface 26 to retrieve the UI description data from the home router repository; instead of receiving them from each individual utility device 130.

In an example embodiment, UI description data may be collected and shared among UEs 110. For example, a smart phone may send UI description data sets to a nearby smartphone automatically or upon request. In another example, a mesh network may collect UI description data for all nodes participating in the mesh network, which may result in a collective UI description data set for all current members of the mesh.

As shown in block 504 of FIG. 5, the apparatus 20 may include a means, such as a processor 22, a communications module 26, or the like, configured to generate a collaged UI for a plurality of utility devices 130. The processor 22 may generate a collaged UI based on the UI description data. A collage UI may be an assemblage of user interface displays or controls in a single visual representation, as depicted in FIG. 3.

In an example embodiment, a pubsub API, such as a JavaScript API, allows interworking of the processor 22 with the UE 110 software modules 200 through specific platform software. The processor 22 may publish the UI description data resource identifiers and resource values using the pubsub API 190. The UI description data resource identifiers and resources values may be mapped and distributed within the apparatus 20. The processor 22 may also subscribe for incoming commands sending a message object command to a software module 200 to listen for new utility devices 130. UI description data may contain references to elements that may be loaded from sources other than the utility device 130. For example, the UI description data may contain a reference to an advertisement service; the UI description data may cause the processor 22 to dynamically load advertisements from the internet resource, while maintaining control information statically from the utility device 130.

In an instance in which the access information is stored in another device, for example, internet servers 150, local external system 160, or internet accessible external system 170, the resource identifier may point to the external device. The resource identifier may be received by the processor 22, which may cause the communications interface 26 to access the external device automatically, without user interaction regarding the access process. In some example embodiments, the processor 22 could implement a translator for external device communication, such as a CoAP proxy. The processor 22 may translate the pubsub API actions to CoAP GET/REPLY messages for communication with nodes in a local area network or the internet.

In an example embodiment, the pubsub API may contain parameters to describe the resource identifier, resource URL, resource data, publication/subscription scope, or the like. The publication/subscription scope may restrict the UI description data, running on the processor 22 to communication only with other software modules 200 within the apparatus 20, with local area network external devices 160, internet external devices 170, or any combination thereof.

In an instance in which the UI description data may access services from external devices or other modules within the apparatus, such as device location data or global position system (GPS), the processor 22 may request permission from the user. The UI description data may support permission framework, which may be mapped to various performance frameworks of the apparatus 20. For example, in an instance in which the UI description data requests access to a GPS function, the processor 22 may request permission that may be mapped to the GPS function.

In an example embodiment, the processor 22 may generate a collaged UI including respective UI description data to run in the same runtime environment, UI description data running in dedicated runtime, in a web browser, or on a native application.

As shown at block 506, of FIG. 5, the apparatus 20 may include means, such as a processor 22, a user interface 28, or the like, configured to cause the collaged UI to be displayed on the user interface 28. In an instance in which the processer displays a collaged UI in a native application, such as Windows® 8 application, the native application may use a panorama view with each utility device in a separate tile, as shown in FIG. 3. The collaged UI may display the control UIs for each utility device, utility device data, or the like. For example the collaged UI may include a control UI for a valve actuator, for example, open or shut, a light and sound sensor data, and a servo positioning control.

As shown at block 508 of FIG. 5, the apparatus 20 may include means, such as a processor 22, user interface 28, or the like, configured to receive a control signal indication. A control signal indication may be generated by user interaction with the collaged UI, such selecting to turn on a utility device 130, positioning a servo, or actuating a valve. In an example embodiment, the processor may be configured to receive automatic control signal indications, for example, without user interaction, which may be a portion of the UI description data, for example utility device data request commands.

In another embodiment, the control signal indication may be directed toward linking at least two utility device UI descriptors data and control functions by binding the utility devices. The process may continue at 510 binding at least two utility devices or 512 causing the transmission of a utility device control signal.

As shown at block 510 of FIG. 5, the apparatus 20 may include means, such as a processor 22, or the like, configured to bind at least two utility devices. A utility device 130 binding may include selection of a utility device output data as the input data for a second utility device. The processor may bind or associate, two or more UI description data elements associated with two or more utility devices 130, such as a sensor and an actuator, causing the output of the sensor to be sent to the actuator as input. The binding or associating utility device elements may be in response to receiving a control signal, as discussed at block 508, or automatically, without user interaction based on a UI description data control information. The apparatus 20 processor 22 acts as the mediator for the data flow using the UI description data, and the sensor and actuator would not need to send data directly between each other. The processor 22 may publish a UI description data element associated with a utility device output data for a first utility device 130. The processor may also subscribe or listen for a UI description data element associated with the first utility device, which may be used as input data for a second utility device 130. For example a motion or a sound sensor may output motion or sound data which may be used as a trigger input to the second utility device, such as a light, to turn on. In an example embodiment, the processor 22 may perform determinations based on the utility device data and generate triggers, or control signals, as input to the second utility device. The process may continue at block 514 receiving utility device data.

As shown at block 512 of FIG. 5, the apparatus 20 may include means, such as a processor 22, communications interface 26, or the like, configured to cause the transmission of a utility device control signal. The processor 22 may cause the communications interface to transmit a utility device control signal based on the received control indication, as discussed at 508, or a trigger, as discussed at 510. The utility device control signal may include a command to be executed by the utility device, such as adjust position of a servo, turn on, turn off, position an actuator, or the like. The communications interface may transmit the utility device control signal using NFC, BLE, or the like.

As shown at block 514 of FIG. 5, the apparatus 20 may include means, such as a processor 22, a communications interface 26 or the like, configured to receive utility device data. The communication interface may receive utility device data from the utility devices 130, which may include sensor data, command execution status data, position indication data, or the like. The processor 22 may update the collaged user interface as discussed in block 516.

In an instance in which a utility device has been bound to the utility device the utility device data, the process may continue at 512 causing the transmission of a utility device control signal. For example in an instance in which a pressure sensor has been bound to a valve actuator, the processor 22 may receive a utility device data of a pressure data satisfying a predetermined threshold, and cause a transmission of a utility device control signal to open to the valve actuator.

As shown at block 516 of FIG. 5, the apparatus 20 may include means, such as a processor 22, a user interface 28, or the like, configured to update the collaged UI. The processor 22 may update the collaged UI based on the received utility device data, such as sensor data, or command execution status. The processor 22 may cause the updated collaged UI to be displayed on the user interface 28 as discussed in 506.

The example embodiments allow for the control of new utility devices without a network connection, without installing dedicated applications, and providing collaged UI to control the utility devices. The pubsub API framework allows UI descriptors to interact with each other, and provide and access services within and external to the UE.

As described above, FIGS. 4 and 5 illustrate flowcharts of an apparatus 20, method, and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus employing an embodiment of the present invention and executed by a processor 22 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as illustrated by the dashed outline of block 408, 508, 510, 512, 514, and 516 in FIGS. 4 and 5. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-44. (canceled)

45. A method comprising:
receiving user interface description data from a plurality of utility devices, wherein the user interface description data comprises access and control data associated with the respective utility device;
generating a collaged user interface based on the user interface description data
receiving a signal associated with a first user interface description data associating the first user interface description data with a second user interface description data; and
causing the collaged user interface to be displayed on a user equipment user interface.

46. The method of claim 45 comprising:
receiving a control signal indication; and
causing the transmission of the control signal to at least one utility device of the plurality of utility devices.

47. The method of claim 45, wherein the signal associating the first and second user interface description data comprises a subscribe or publish message.

48. The method of claim 45 further comprising:
receiving utility device data; and
updating the collaged user interface based on the received utility device data.

49. The method of claim 45, wherein the user interface description data further comprises resource identifiers.

50. An apparatus comprising at least one processor and at least one memory including computer program code, the at least one memory and computer program code configured to, with the processor, cause the apparatus to at least:
receive user interface description data from a plurality of utility devices, wherein the user interface description data comprises access and control data associated with the respective utility device;
generate a collaged user interface based on the user interface description data
receive a signal associated with a first user interface description data associating the first user interface description data with a second user interface description data; and
cause the collaged user interface to be displayed on a user interface.

51. The apparatus of claim 50, wherein the at least one memory and the computer program code are further configured to:
receive a control signal indication; and
cause the transmission of the control signal to at least one utility device of the plurality of utility devices.

52. The apparatus of claim 50, wherein the at least one memory and the computer program code are further configured to:
receive utility device data; and
update the collaged user interface based on the received utility device data.

53. The apparatus of claim 50, wherein the signal associating the first and second user interface description data comprises a subscribe or publish message.

54. The apparatus of claim 50, wherein the user interface description data further comprises support permission request data.

55. A computer program product comprising at least one non-transitory computer-readable storage medium having computer-executable program portions stored therein, the computer-executable program code portions comprising program code instructions configured to:
receive user interface description data from a plurality of utility devices, wherein the user interface description data comprises access and control data associated with the respective utility device;
generate a collaged user interface based on the user interface description data
receive a signal associated with a first user interface description data associating the first user interface description data with a second user interface description data; and
cause the collaged user interface to be displayed on a user equipment user interface.

56. The computer program product of claim 55, wherein the computer-executable program code portions further comprise program code instructions configured to:
receive a control signal indication; and
cause the transmission of the control signal to at least one utility device of the plurality of utility devices.

57. The computer program product of claim 55, wherein the signal associating the first and second user interface description data comprises a subscribe or publish message.

58. The computer program product of claim 55, wherein the computer-executable program code portions further comprise program code instructions configured to:
receive utility device data; and
update the collaged user interface based on the received utility device data.
